(19) United States
(12) Patent Application Publication
(10) Pub. No.: US 2005/0201612 A1
(43) Pub. Date: Sep. 15, 2005

(54) Method and apparatus for detecting people using stereo camera

(75) Inventors: Gyutae Park, Anyang-si (KR); Kyungah Sohn, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co.,Ltd., Suwon-Si (KR)

(21) Appl. No.: 11/068,915

(22) Filed: Mar. 2, 2005

(30) Foreign Application Priority Data
Mar. 4, 2004 (KR) 10-2004-0014595

(51) Int. Cl. G06K 9/00

(52) U.S. Cl. 382/154; 382/103

(57) ABSTRACT

A method of and apparatus for detecting people using a stereo camera. The method includes: calculating three-dimensional information regarding a moving object from a pair of image signals received from the stereo camera using stereo matching and creating a height map for a specified discrete volume of interest (VOI) using the three-dimensional information; detecting a people candidate region estimated as including one or more persons by finding connected components from the height map using a predetermined algorithm; and generating a histogram with respect to the people candidate region, detecting different height regions using the histogram, and detecting a head region by analyzing the different height regions using a tree structure.

### CROSS-REFERENCE TO RELATED APPLICATION

This application claims the priority of Korean Patent Application No. 2004-14595, filed on Mar. 4, 2004, in the Korean Intellectual Property Office, the disclosure of which is incorporated herein by reference.

### BACKGROUND OF THE INVENTION

1. Field of the Invention

The present invention relates to technology for detecting people, and more particularly, to a method and apparatus for detecting people using a stereo camera.

2. Description of Related Art

Technology for detecting people in real time is needed in various fields such as security and marketing. Methods of detecting people within a specified range have been researched and developed. Infrared methods, laser methods, and line scan methods use a sensor. These methods have a problem in that people are not distinguished from other objects.

To solve the problem, methods using cameras have been proposed. Methods using a single camera installed on a ceiling have problems in that detection accuracy is low due to shadow and reflection caused by lighting and that a viewing angle is narrow. Methods using a stereo camera have been proposed to solve these problems. A method of counting a plurality of people in a linear queue is disclosed in U.S. Pat. No. 5,581,625, entitled “Stereo Vision System for Counting Items in a Queue.” However, in that method, people crowding at one time cannot be accurately counted. In addition, a camera used in the method needs to have a wide viewing angle due to an installation requirement that a ceiling usually has a height of about 3 m. However, when people are detected from image signals obtained by a camera having a wide viewing angle, detection accuracy is not satisfactory.

Meanwhile, methods of detecting people using a front or a side camera have been proposed. Methods of detecting people using a side camera are disclosed in U.S. Pat. Nos. 5,953,055 and 6,195,121. However, in these methods, occlusion in which a moving object behind another moving object is not detected. As a result, people moving and passing by a camera cannot be accurately detected.

### BRIEF SUMMARY

An aspect of the present invention provides a method and apparatus for accurately detecting people using a stereo camera having a wide viewing angle.

According to an aspect of the present invention, there is provided a method of detecting people using a stereo camera. The method includes: calculating three-dimensional information regarding a moving object from a pair of image signals received from the stereo camera and creating a height map for a specified discrete volume of interest (VOI) using the three-dimensional information; detecting a people candidate region by finding connected components from the height map; and generating a histogram with respect to the people candidate region, detecting different height regions using the histogram, and detecting a head region from the different height regions.

The operation of calculating the three-dimensional information and creating the height map may include comparing the two image signals to measure a disparity between a right image and a left image using either of the right and left images as a reference, calculating the three-dimensional information by calculating a depth from the stereo camera using the disparity, converting the three-dimensional information into a two-dimensional coordinate system with respect to the specified discrete volume of interest (VOI), and creating the height map by calculating heights with respect to each pixel in the two-dimensional coordinate system using the three-dimensional information and defining a maximum height among the calculated heights as a height of the pixel. Height information in the height map may be displayed in a specified number of gray levels. The method may further include filtering the height map to remove objects other than the moving object before the calculation of the three-dimensional information. The filtering of the height map may include at least one filtering selected from among median filtering which removes an isolated point or impulsive noise from the height map, thresholding which removes a pixel having a height lower than a specified threshold from the height map, and morphological filtering which removes noise by performing combinations of multiple morphological operations. The operation of generating the histogram, detecting the different height regions, and detecting the head region may include Gaussian filtering the histogram. Alternatively, the operation of generating the histogram, detecting the different height regions, and detecting the head region may include searching for a local minimum point in the histogram and detecting the different height regions using the local minimum point as a boundary value, generating a tree structure with respect to the different height regions using an inclusion test, searching for terminal nodes in the tree structure, and detecting a region of a terminal node including a greater number of pixels than a reference value as the head region.

According to another embodiment of the present invention, there is provided a method of detecting people using a stereo camera, the method including: detecting a people candidate region from a pair of image signals received from the stereo camera; generating a histogram with respect to the people candidate region; searching for a local minimum point in the histogram and detecting different height regions using the local minimum point as a boundary value; and detecting a region having a maximum height among the different height regions as a head region.

According to another aspect of the present invention, there is provided an apparatus for detecting people, including: a stereo camera; a stereo matching unit calculating three-dimensional information regarding a moving object from a pair of image signals received from the stereo camera; a height map creator creating a height map for a specified discrete volume of interest (VOI) using the three-dimensional information; a candidate region detector detecting a people candidate region by finding connected components from the height map; and a head region detector generating a histogram with respect to the people candidate region, detecting different height regions using the histogram, and detecting a head region from the different height regions.

The apparatus may further include a filtering processor filtering the height map to remove objects other than the moving object.

According to another embodiment of the present invention, there is provided a method of detecting a person, including: receiving first and second images from a stereo camera; calculating a distance between the stereo camera and a photographed object a depth using stereo matching; creating a height map with respect to a volume of interest (VOI) using the calculated depth; filtering the height map; detecting a people candidate region of the filtered height map; detecting different height regions of the filtered height map using a histogram of the of the people candidate region; and detecting a head region using a tree-structure analysis.

According to other aspects of the present invention, there are provided computer-readable storage media encoded with processing instructions for causing a processor to perform the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which

FIG. 1 is a block diagram of an apparatus for detecting people using a stereo camera according to an embodiment of the present invention;

FIG. 2 is a flowchart of a method of detecting people using a stereo camera according to an embodiment of the present invention;

FIGS. 3A through 3I show images processed in stages of the method according to the embodiment illustrated in FIG. 2;

FIGS. 4A and 4B illustrate a volume of interest (VOI) and a discrete VOI processed using the method according to the embodiment illustrated in FIG. 2;

FIG. 5 is a detailed flowchart of operation S220 shown in FIG. 2;

FIG. 6 is a detailed flowchart of operation S230 shown in FIG. 2;

FIG. 7 is a detailed flowchart of operation S250 shown in FIG. 2;

FIGS. 8A through 8D illustrate a procedure for detecting a head region from a region of a single person using a histogram, wherein FIG. 8A illustrates an image only in the region of the single person, FIG. 8B illustrates a height map for the single-person region, FIG. 8C illustrates a histogram for the single-person region, and FIG. 8D illustrates a histogram after being subjected to Gaussian filtering;

FIG. 9 is a detailed flowchart of operation S260 shown in FIG. 2; and

FIG. 10 illustrates tree structures of different height regions in the image shown in FIG. 3A.

### DETAILED DESCRIPTION

Reference will now be made in detail to embodiments of the present invention, examples of which are illustrated in the accompanying drawings, wherein like reference numerals refer to the like elements throughout. The embodiments are described below in order to explain the present invention by referring to the figures.

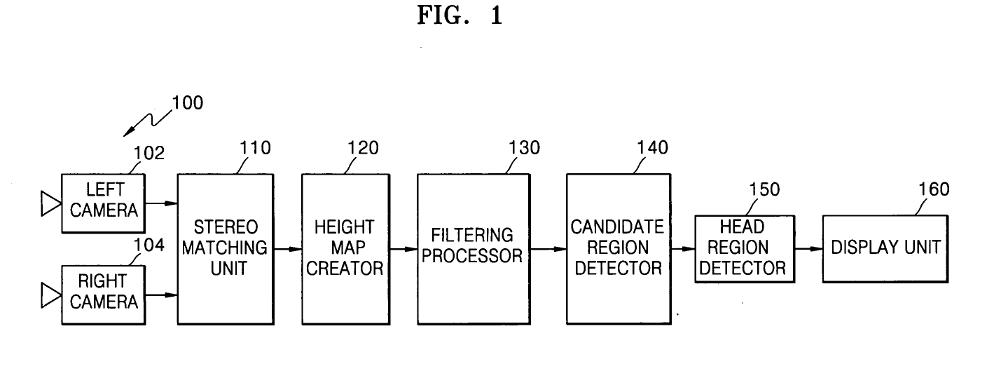

Referring to FIG. 1, an apparatus for detecting people using a stereo camera according to an embodiment of the present invention includes a stereo camera 100, a stereo matching unit 110, a height map creator 120, a filtering processor 130, a candidate region detector 140, a head region detector 150, and a display unit 160. The stereo camera 100 includes a left camera 102 and a right camera 104 which are fixed to a ceiling.

The stereo matching unit 110 performs warping, camera calibration, and rectification on a pair of image signals received from the stereo camera 100 and measures a disparity between the two image signals to obtain 3-dimensional (3D) information. Warping is a process of compensating for distortion in an image using interpolation. Rectification is a process of making an optical axis of an image input from the left camera 102 and an optical axis of an image input from the right camera 104 identical with each other. The disparity between the two image signals is a positional variation between corresponding pixels in the two image signals respectively obtained from the left and right cameras 102 and 104 when either of the left and right images is used as a reference image.

The height map creator 120 obtains a depth from the stereo camera 100, i.e., a distance between the stereo camera 100 and an object using the disparity obtained by the stereo matching unit 110, and creates a height map with respect to a volume of interest (VOI) using the depth.

The filtering processor 130 removes portions other than a moving object from the height map and may include a median filter, a thresholding part, and a morphological filter. The median filter removes an isolated point or impulsive noise from an image signal. The thresholding part removes a portion having a height lower than a specified threshold. The morphological filter effectively removes noise by performing combinations of multiple morphological operations.

The candidate region detector 140 detects a people candidate region, which is estimated as including at least one person, from the height map by using a connected component analysis (CCA) algorithm as a labeling scheme. The CCA algorithm finds all components connected in an image and allocates a unique label to all points of each component.

The head region detector 150 generates a histogram for the people candidate region, detects different height regions from the histogram, and analyzes the different height regions in a tree structure, thereby detecting a person's head region. The display unit 160 outputs the detected head region in the form of an analog image signal.

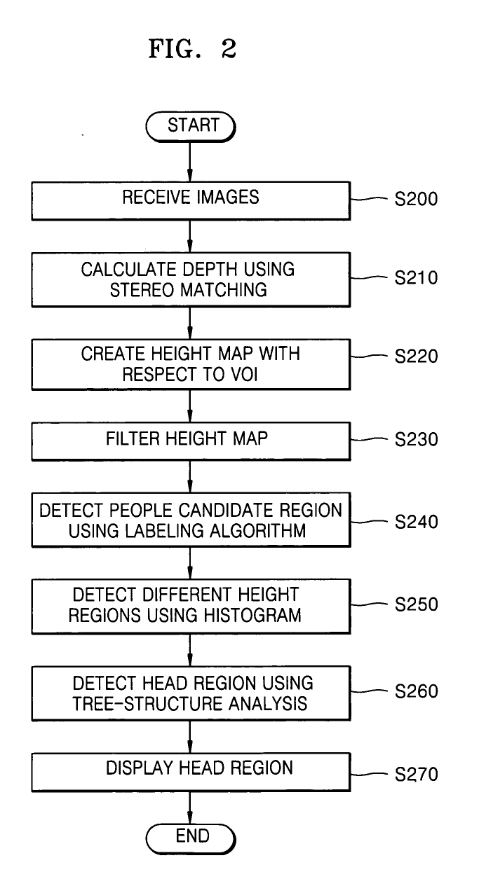

FIG. 2 is a flowchart of a method of detecting people using a stereo camera according to an embodiment of the present invention. The method will be described in association with the elements shown in FIG. 1.

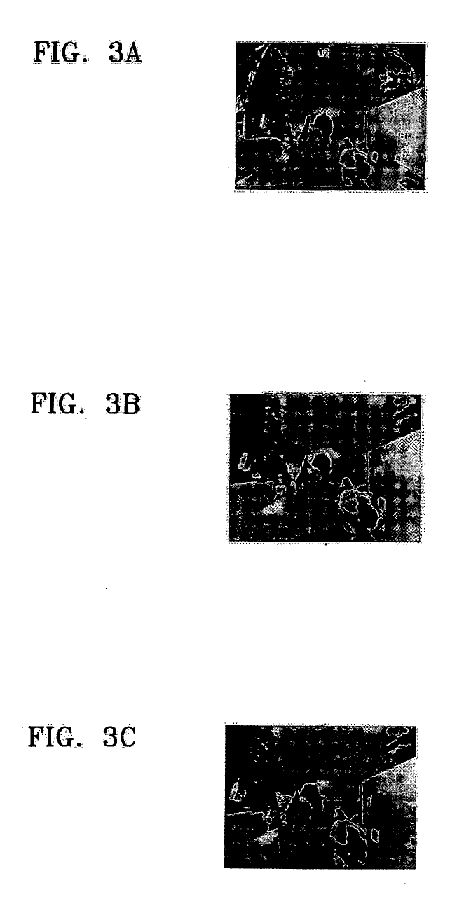

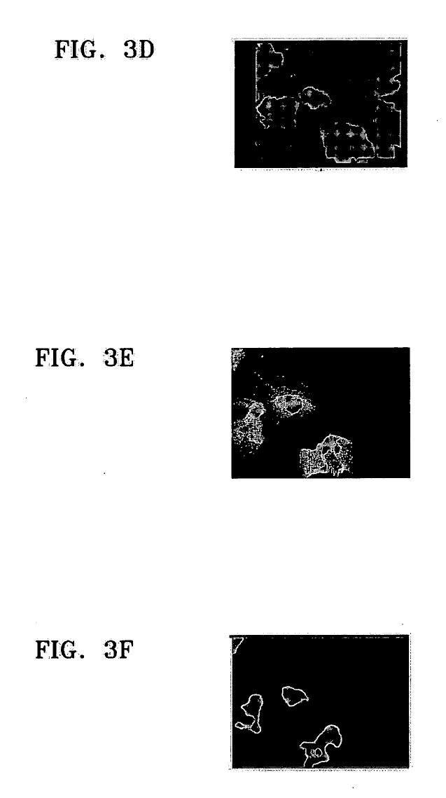

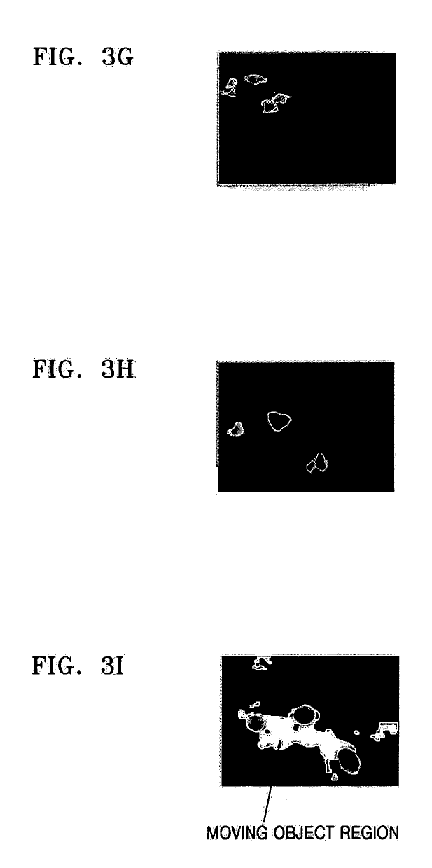

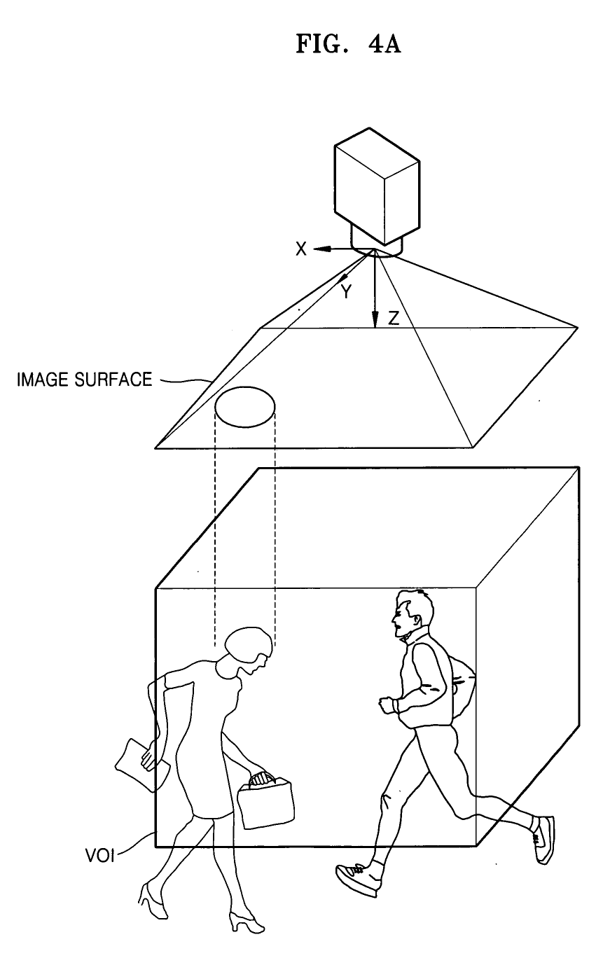

Referring to FIGS. 1 and 2, images photographed with the stereo camera 100 are received in operation S200. FIG. 3A shows an input image from the left camera 102 of the stereo camera 100. Analog image signals received from the stereo camera 100 are converted into digital image signals by an image grabber (not shown).

Thereafter, a depth, i.e., a distance between the stereo camera 100 and an object is calculated from a disparity between a left image and a right image using stereo matching in operation S210. During the stereo matching, warping and rectification are performed on the digital image signals. FIGS. 3B and 3C show the left and right images, respectively, after being subjected to the warping and the rectification. A disparity in each pixel between the left and right images after being subjected to the warping and the rectification is measured. FIG. 3D shows a disparity map between the left and right images. A depth “z” is calculated from the disparity between the left and right images using Equation (1).

$$z = \frac{L \cdot f}{Δ r} \qquad ( 1 )$$

Here, “L” is a distance between the left camera 102 and the right camera 104, “f” is a focal length of the stereo camera 100, and “Δr” is a disparity between the left image and the right image.

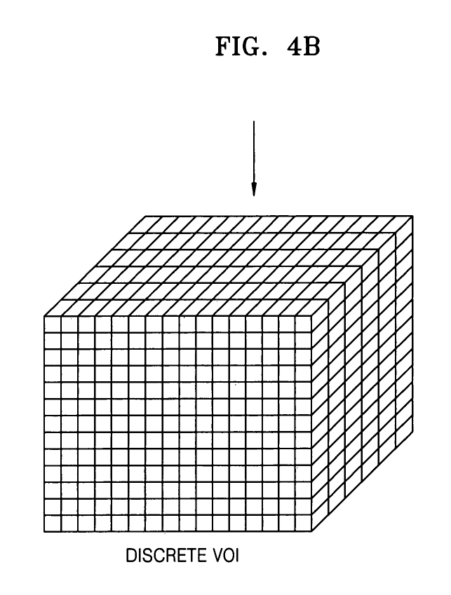

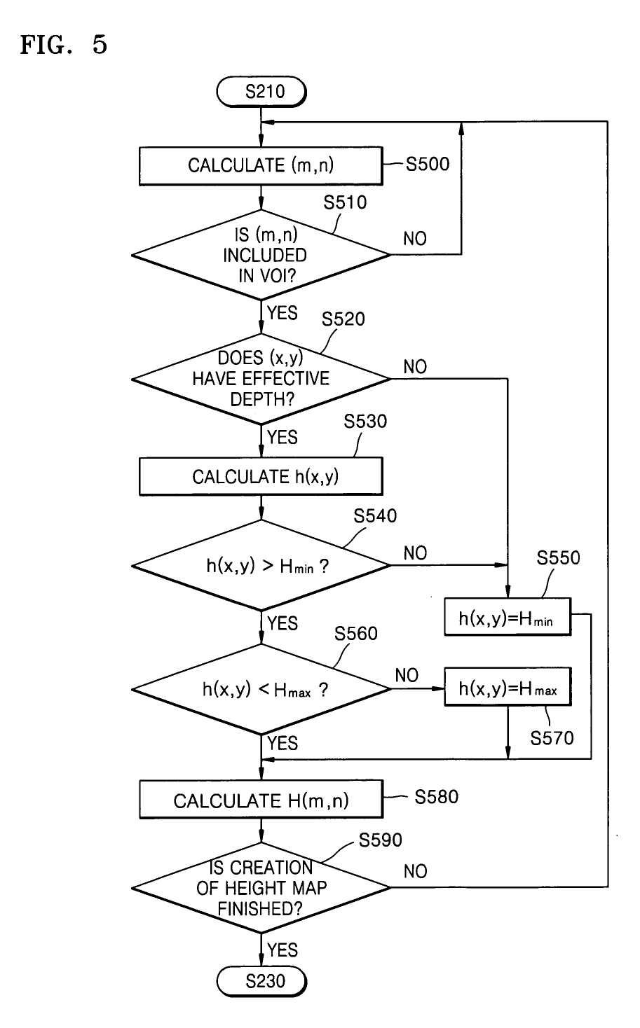

Thereafter, a height map is created with respect to a VOI in operation S220. FIGS. 4A and 4B illustrate a VOI and a discrete VOI, respectively. In the embodiment illustrated in FIG. 2, a size of the VOI is set to 2.67 m×2 m×1.6 m, and dX, dY, and dZ are set to 8.333, 8.333, and 6.25 mm, respectively. Accordingly, a 2-dimensional (2D) coordinate system of the VOI is defined as 320×240, and a height of the VOI is defined as 256. Therefore, height information of the height map is displayed in gray levels ranging from 0 to 255. FIG. 3E shows the height map with respect to the VOI created using the disparity map shown in FIG. 3D. The creating of the height map will be described with reference to FIG. 5 later.

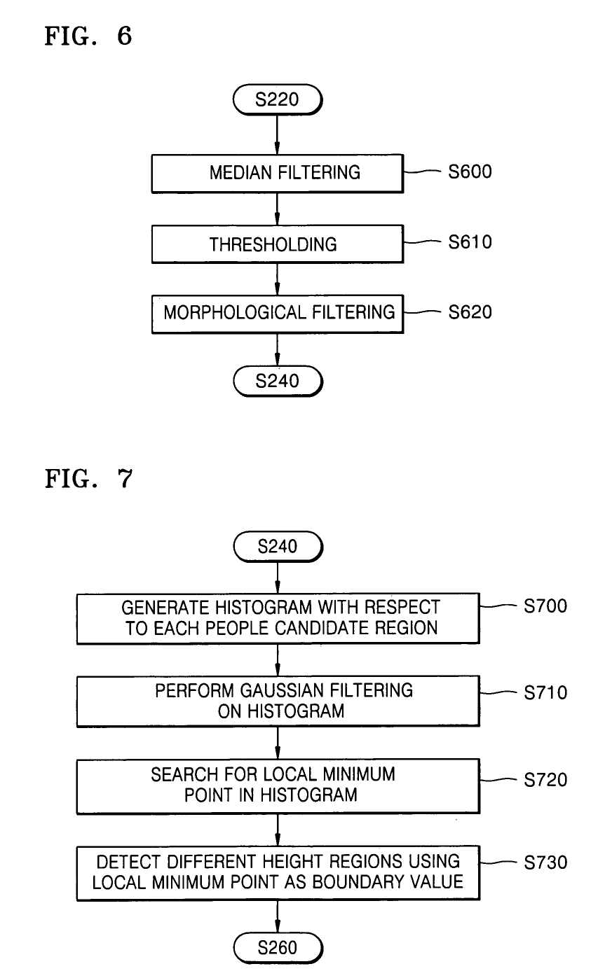

Thereafter, the height map is filtered in operation S230. FIG. 3F shows a result of filtering the height map shown in FIG. 3E. Operation S230 will be described with reference FIG. 6 later.

Thereafter, a people candidate region is detected from the filtered height map using a CCA algorithm in operation S240. To detect the people candidate region, all connected components are found in the image using the CCA algorithm, and different labels are allocated to the connected components, respectively. The CCA algorithm may be used as a labeling method. The CCA algorithm has been researched and includes various types such as linear processing, hierarchical processing, and parallel processing. Different types of CCA algorithm have their own merits and demerits, and have different computing times depending upon complexity of components. Accordingly, a CCA algorithm needs to be appropriately selected according to a place where people detection is performed.

Thereafter, different height regions are detected using a histogram of the people candidate region in operation S250. FIG. 3G shows a result of detecting different height regions with respect to the filtered height map shown in FIG. 3F. Detecting the different height regions will be described with reference to FIG. 7 later.

After detecting the different height regions with respect to the people candidate region, a head region is detected using a tree-structure analysis in operation S260. FIG. 3H shows a result of detecting the head region from the different height regions shown in FIG. 3G. Detecting the head region will be described with reference to FIG. 9 later.

Thereafter, the detected head region is displayed in operation S270. An image representing the detected head region may be ORed with an image representing a moving object and then displayed on the display unit 170. The image representing the moving object is generated by a moving object segmentation unit (not shown) that separates a moving object from an input image. This ORing operation is performed to prevent a stationary object from being detected as a human head. FIG. 3I shows a result of displaying the detected head regions shown in FIG. 3H. The detected head regions are displayed as elliptical portions in FIG. 3I.

FIG. 5 is a detailed flowchart of operation S220 shown in FIG. 2. Referring to FIG. 5, a 2D coordinate value (m,n) of the VOI is calculated using (x,y) among 3D positional information regarding an arbitrary pixel in operation S500. The calculation is accomplished using a windowing conversion as shown in Equations (2) and (3).
m=a₁x+b₁ (2)
n=a₂y+b₂ (3)
Here, a₁, b₁, a₂, and b₂ are defined by an entire size of the 3D positional information and a size of a 2D coordinate system of the VOI, which are obtained from the images taken by the stereo camera 100.

Thereafter, it is determined whether the 2D coordinate value (m,n) is included in the VOI in operation S510. If it is determined that the 2D coordinate value (m,n) is not included in the VOI, another 2D coordinate value (m,n) is calculated with respect to another pixel (x,y) in operation S500. If it is determined that the 2D coordinate value (m,n) is included in the VOI, it is determined whether the pixel (x,y) has an effective depth in operation S520. When there is no texture, the pixel (x,y) does not have an effective depth. For example, when a person wrapping himself/herself in a black cloak passes, a disparity cannot be measured. If the pixel (x,y) does not have an effective depth, a height h(x,y) of the pixel (x,y) is set to Hₘᵢₙ in operation S550. Hₘᵢₙ may indicate a lowest height (0 in embodiments of the present invention) of the VOI but may indicate a different value according to a user's setup. If the pixel (x,y) has an effective depth, the height h(x,y) is calculated using a depth “z” in operation S530. Like the 2D coordinate value (m,n), the height h(x,y) is calculated using a windowing conversion as shown in Equation (4).
h(x,y)=cz+d (4)
Here, “c” and “d” are determined by a maximum depth and a height of the VOI among the 3D positional information obtained from the images taken by the stereo camera 100.

It is determined whether h(x,y) is greater than Hₘᵢₙ in operation S540. If it is determined that h(x,y) is not greater than Hₘᵢₙ, h(x,y) is set to Hₘᵢₙ in operation S550. If it is determined that h(x,y) is greater than Hₘᵢₙ, it is determined whether h(x,y) is less than Hₘₐₓ in operation S560. Hₘₐₓ may indicate a highest height (255 in embodiments of the present invention) of the VOI but may indicate a different value according to the user's setup. If it is determined that h(x,y) is not less than Hₘₐₓ, h(x,y) is set to Hₘₐₓ in operation S570. If it is determined that h(x,y) is less than Hₘₐₓ, H(m,n) is calculated in operation S580. When pixels (x,y) are converted into 2D coordinate values (m,n), there may be a plurality of pixels (x,y) converted into the same 2D coordinate value (m,n). Accordingly, H(m,n) indicates a highest height among the heights of the pixels (x,y) having the same 2D coordinate value (m,n) in the discrete VOI, and is calculated by Equation (5).
H(m,n)=Max h(x,y)δ(γ(x,y)−(m,n)) (5)
Here, γ(x,y)=(m,n), and δ is a Kronecker delta function.

Next, it is determined whether creation of the height map is finished in operation S590. Since height map creation is performed on each pixel, it is determined whether heights of all pixels have been obtained. It is determined that the creation of the height map is not finished, the method returns to operation S500.

FIG. 6 is a detailed flowchart of operation S230 shown in FIG. 2. Filtering performed in operation S230 includes at least one filtering among median filtering in operation S600, thresholding in operation S610, and morphological filtering in operation S620.

The median filtering is performed in operation S600. In other words, a window is set on the height map, pixels within the window are arranged in order, and a median value of the window is set to a value of a pixel corresponding to a center of the window. The median filtering removes noise and maintains contour information of an object. Thereafter, the thresholding is performed to remove pixels having values less than a specified threshold in operation S610. Thresholding corresponds to a high-pass filter. Thereafter, the morphological filtering is performed to effectively removing noise by combining multiple morphological operations in operation S620. In embodiments of the present invention, an opening operation where an erosion operation is followed by a dilation operation is performed. In other words, an outermost edge of an image is erased pixel by pixel using the erosion operation to remove noise, and then, the outermost edge of the image is extended pixel by pixel using the dilation operation, so that an object becomes prominent.

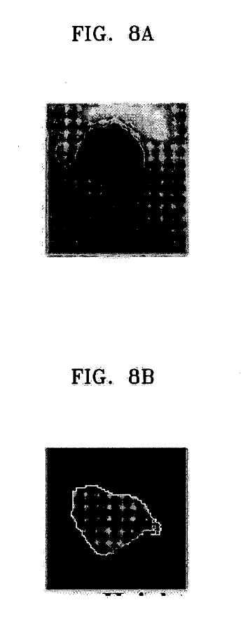

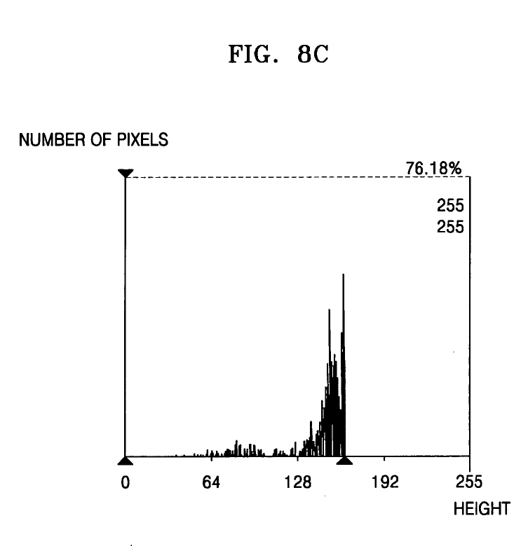

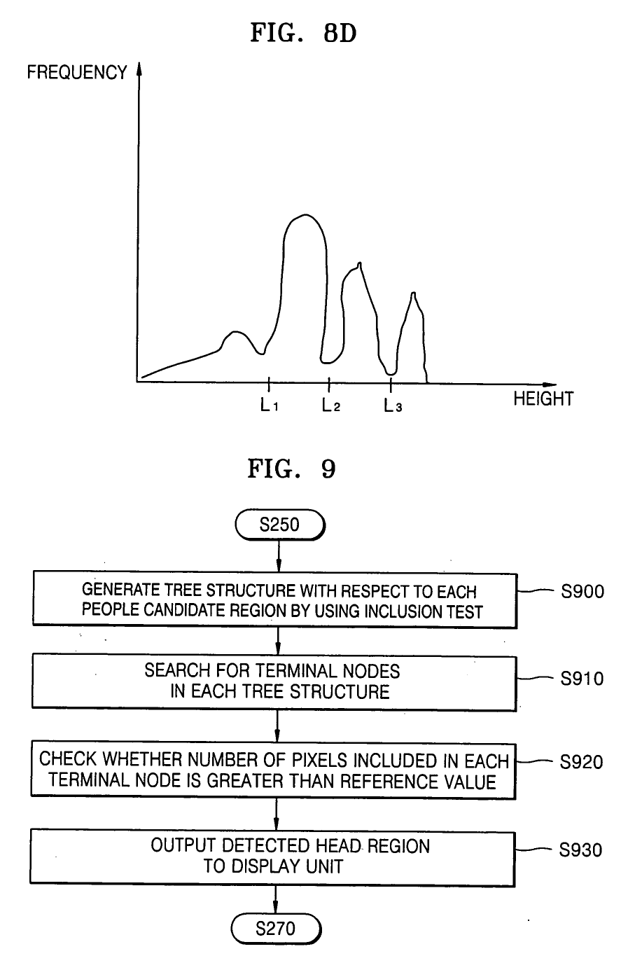

FIG. 7 is a detailed flowchart of operation S250 shown in FIG. 2. As shown in FIG. 7, the histogram is generated with respect to the people candidate region in operation S700. FIGS. 8A through 8D illustrate a procedure in which a height map is created with respect to a region of a single person, a histogram is generated using the height map, and a head region is detected. FIG. 8A illustrates an image of a single-person region. FIG. 8B illustrates a height map of the image shown in FIG. 8A. FIG. 8C illustrates a histogram generated using the height map shown in FIG. 8B.

The generated histogram is Gaussian filtered in operation S710. Gaussian filtering is referred to as histogram equalization and is used to generate a histogram having a uniform distribution. The histogram equalization is not equalizing a histogram but is redistributing light and shade. The histogram equalization is performed to facilitate a local minimum point search in a subsequent operation. FIG. 8D illustrates a result of Gaussian filtering the histogram shown in FIG. 8C.

A local minimum point is searched for in the Gaussian-filtered histogram in operation S720. The local minimum point is searched for using a between-class scatter, entropy, histogram transform, preservation of moment, or the like.

Thereafter, the different height regions are detected using the local minimum point as a boundary value in operation S730. As shown in FIG. 8A, when there is one person, the different height regions can be detected from the Gaussian-filtered histogram shown in FIG. 8D. When it is assumed that the different height regions are divided into a head portion, a shoulder portion, and a leg portion, the number of pixels distributed above a local minimum point L₃ corresponding to a highest height in the histogram corresponds to a region to the head portion. The number of pixels distributed above a local minimum point L₂ corresponding to a second highest height in the histogram corresponds to a region to the shoulder portion. The number of pixels distributed above a local minimum point L₁ corresponding to a third highest height in the histogram corresponds to a region to the leg portion. However, when a plurality of persons exist in one people candidate region, the different height regions cannot be accurately detected using only the histogram. Accordingly, the different height regions are detected from a height map of the people candidate region using a local minimum point as a boundary value. If a result of Gaussian filtering the people candidate region including the plurality of persons appears as shown in FIG. 8D, the numbers of pixels distributed above the local minimum points L₃, L₂, and L₁, respectively, in the height map are calculated, and the different height regions are detected.

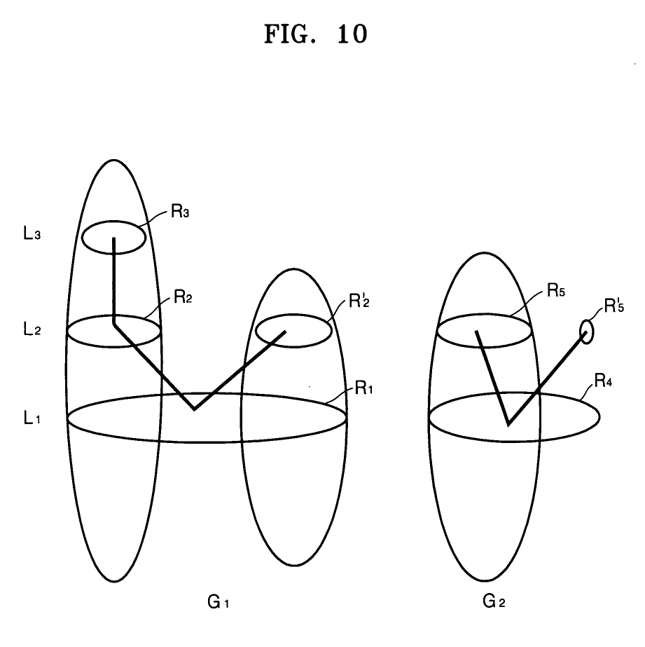

FIG. 9 is a detailed flowchart of operation S260 shown in FIG. 2. A tree structure is generated with respect to the people candidate region by using an inclusion test in operation S900. FIG. 10 illustrates tree structures of the different height regions with respect to the image shown in FIG. 3A. Referring to FIG. 10, since L₁<L₂, and R₁ and R₂ are included in a people candidate region G₁, R₂ is a lower node of R₁ Here, “L” indicates a height of the different height regions, and “R” indicates the number of pixels corresponding to the different height regions. As such, R₂′ is a lower node of R₁.

Thereafter, terminal nodes are searched for in each tree structure in operation S910. The terminal nodes have no lower nodes. In FIG. 10, R₃, R₂′, R₅, and R₅′ denote terminal nodes.

Subsequently, it is determined whether the number of pixels in a region of each of the searched terminal nodes is greater than a reference value in operation S920. Referring to FIG. 10, the terminal node R₅′ includes a less number of pixels than the reference value, which indicates a hand, a thing carried with a person, or the like. Accordingly, regions of the terminal nodes except for a terminal node including a less number of pixels than the reference value are detected as head regions. The detected head regions are output to the display unit 170 in operation S930.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the present invention, a height map is created with respect to an image signal received from a stereo camera, and persons' heads are detected by using a histogram with respect to the height map and by performing tree-structure analysis on the height map, so that a plurality of persons can be accurately counted. In addition, even if the stereo camera has a wide viewing angle, people can be accurately counted.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of detecting people using a stereo camera, comprising:
calculating three-dimensional information regarding a moving object from a pair of image signals received from the stereo camera and creating a height map for a specified discrete volume of interest (VOI) using the three-dimensional information;
detecting a people candidate region by finding connected components from the height map; and
generating a histogram with respect to the people candidate region, detecting different height regions using the histogram, and detecting a head region from the different height regions.

2. The method of claim 1, wherein the operation of calculating the three-dimensional information and creating the height map includes:
comparing the two image signals to measure a disparity between a right image and a left image using either of the right and left images as a reference;
calculating the three-dimensional information by calculating a depth from the stereo camera using the disparity;
converting the three-dimensional information into a two-dimensional coordinate system with respect to the specified discrete volume of interest (VOI); and
creating the height map by calculating heights with respect to each pixel in the two-dimensional coordinate system using the three-dimensional information and defining a maximum height among the calculated heights as a height of the pixel.

3. The method of claim 2, wherein, in the calculating the three-dimensional information by calculating a depth from the stereo camera using the disparity, the depth is calculated from the disparity between the left and right images by the following equation
$$z = \frac{L \cdot f}{Δ r} ,$$
wherein “z′ is the depth, “L” is a distance between the left camera and the right camera, “f” is a focal length of the stereo camera, and “Δr” is the disparity between the left image and the right image.

4. The method of claim 2, wherein, in the creating, a two-dimensional coordinate value (m,n) of the VOI is calculated among three-dimensional positional information regarding an arbitrary pixel by the following equations
m=a₁x+b₁ and
n=a₂y+b₂, and
wherein a₁, b₁, a₂, and b₂ are defined by an entire size of the three-dimensional positional information and a size of a two-dimensional coordinate system of the VOI, which are obtained from the images taken by the stereo camera.

5. The method of claim 1, wherein height information in the height map is displayed in a specified number of gray levels.

6. The method of claim 1, further comprising filtering the height map to remove objects other than the moving object before the calculating of the three-dimensional information.

7. The method of claim 6, wherein the filtering of the height map includes at least one filtering selected from the group consisting of:
median filtering which removes an isolated point or impulsive noise from the height map;
thresholding which removes a pixel having a height lower than a specified threshold from the height map; and
morphological filtering which removes noise by performing combinations of multiple morphological operations.

8. The method of claim 1, wherein the operation of generating the histogram, detecting the different height regions, and detecting the head region includes:
searching for a local minimum point in the histogram and detecting the different height regions using the local minimum point as a boundary value; and
detecting a region having a maximum height among the different height regions as the head region.

9. The method of claim 1, wherein the operation of generating the histogram, detecting the different height regions, and detecting the head region includes:
searching for a local minimum point in the histogram and detecting the different height regions using the local minimum point as a boundary value;
generating a tree structure with respect to the different height regions using an inclusion test;
searching for terminal nodes in the tree structure; and
detecting a region of a terminal node including a greater number of pixels than a reference value as the head region.

10. The method of claim 1, wherein the operation of generating the histogram, detecting the different height regions, and detecting the head region includes Gaussian filtering the histogram.

11. A method of detecting people using a stereo camera, comprising:
detecting a people candidate region from a pair of image signals received from the stereo camera;
generating a histogram with respect to the people candidate region;
searching for a local minimum point in the histogram and detecting different height regions using the local minimum point as a boundary value; and
detecting a region having a maximum height among the different height regions as a head region.

12. The method of claim 11, wherein the detecting of the people candidate region includes:
calculating three-dimensional information regarding a moving object from the pair of image signals;
creating a height map for a specified discrete volume of interest (VOI) using the three-dimensional information; and
detecting the people candidate region by finding connected components from the height map.

13. An apparatus for detecting people, comprising:
a stereo camera;
a stereo matching unit calculating three-dimensional information regarding a moving object from a pair of image signals received from the stereo camera;
a height map creator creating a height map for a specified discrete volume of interest (VOI) using the three-dimensional information;
a candidate region detector detecting a people candidate region by finding connected components from the height map; and
a head region detector generating a histogram with respect to the people candidate region, detecting different height regions using the histogram, and detecting a head region from the different height regions.

14. The apparatus of claim 13, wherein the three-dimensional information is converted into a two-dimensional coordinate system with respect to the specified discrete volume of interest (VOI), and a maximum height among heights calculated with respect to each pixel in the two-dimensional coordinate system using the three-dimensional information is height information of the height map.

15. The apparatus of claim 13, wherein height information in the height map is displayed in a specified number of gray levels.

16. The apparatus of claim 13, further comprising a filtering processor filtering the height map to remove objects other than the moving object.

17. The apparatus of claim 16, wherein the head region detector searches for a local minimum point in the histogram and detects as the head region a region having a maximum height among the different height regions detected using the minimum point as a boundary value.

18. A computer-readable storage medium encoded with processing instructions for causing a processor to perform a method of detecting people using a stereo camera, the method comprising:
calculating three-dimensional information regarding a moving object from a pair of image signals received from the stereo camera and creating a height map for a specified discrete volume of interest (VOI) using the three-dimensional information;
detecting a people candidate region by finding connected components from the height map; and
generating a histogram with respect to the people candidate region, detecting different height regions using the histogram, and detecting a head region from the different height regions.

19. A computer-readable storage medium encoded with processing instructions for causing a processor to perform a method of detecting people using a stereo camera, the method comprising:
detecting a people candidate region from a pair of image signals received from the stereo camera;
generating a histogram with respect to the people candidate region;
searching for a local minimum point in the histogram and detecting different height regions using the local minimum point as a boundary value; and
detecting a region having a maximum height among the different height regions as a head region.

20. A method of detecting a person, comprising:
receiving first and second images from a stereo camera;
calculating a distance between the stereo camera and a photographed object a depth using stereo matching;
creating a height map with respect to a volume of interest (VOI) using the calculated depth;
filtering the height map;
detecting a people candidate region of the filtered height map;
detecting different height regions of the filtered height map using a histogram of the of the people candidate region; and
detecting a head region using a tree-structure analysis.

21. A computer-readable storage medium encoded with processing instructions for causing a processor to perform a method of detecting a person, the method comprising:
receiving first and second images from a stereo camera;
calculating a distance between the stereo camera and a photographed object a depth using stereo matching;
creating a height map with respect to a volume of interest (VOI) using the calculated depth;
filtering the height map;
detecting a people candidate region of the filtered height map;
detecting different height regions of the filtered height map using a histogram of the of the people candidate region; and
detecting a head region using a tree-structure analysis.
